(19) United States
(12) Patent Application Publication
(10) Pub. No.: US 2016/0072582 A1
(43) Pub. Date: Mar. 10, 2016

(54) VISIBLE LIGHT COMMUNICATION DEVICE AND RECEIVING DEVICE

(71) Applicant: Panasonic Intellectual Property Management Co., Ltd., Osaka (JP)

(72) Inventor: Shojirou KIDO, Osaka (JP)

(21) Appl. No.: 14/829,693

(22) Filed: Aug. 19, 2015

(30) Foreign Application Priority Data
Sep. 9, 2014 (JP) 2014-183714

(51) Int. Cl. H04B 10/116; H04L 1/00; H04B 10/524

(52) U.S. Cl. CPC H04B 10/116; H04B 10/524; H04L 1/0061; H04L 1/0042; H04L 1/0047

(57) ABSTRACT

A visible light communication device includes a light source unit that emits light for visible light communication, and a signal control circuit that generates an original signal of light emitted by the light source unit. The original signal generated by the control circuit includes: a payload part including identification information identifying the visible light communication device, a Cyclic Redundancy Check (CRC) part determined according to data of the payload; and a recognition part arranged immediately subsequent to the CRC part.

### CROSS REFERENCE TO RELATED APPLICATION

This application claims the benefit of priority of Japanese Patent Application Number 2014-183714, filed Sep. 9, 2014, the entire content of which is hereby incorporated by reference.

### BACKGROUND OF THE INVENTION

1. Field of the Invention

The present disclosure relates to visible light communication devices and receiving devices.

2. Description of the Related Art

In recent years, there are visible light communication devices that transmit signals by modulating the intensity of illumination light. Since such visible light communication devices can transmit signals by modulating the intensity of illumination light, they do not need to have a specific device for signal transmission. Furthermore, use of light-emitting diodes as illumination light sources enables the visible light communication devices to save power. Therefore, the visible light communication devices have been examined to be applied to ubiquitous information systems in underground malls and the like.

An example of such illumination light communication devices is disclosed in Japanese Unexamined Patent Application Publication No. 2012-69505 (Patent Literature 1) in which an illumination light communication device is provided with a simple circuit for visible light communication and is capable of faithfully modulating the intensity of an output light according to communication signals of high-frequency waves.

Meanwhile, “JEITA CP-1223 Kashikou Bikon Sisutemu” published on May, 2013 (Non-Patent Literature 1) discloses CP-1223 standard that is established by Japan Electronics and Information Technology Industries Association (JEITA) as a protocol for transmission signals in visible light communication performed by visible light beacon systems.

### SUMMARY OF THE INVENTION

If information is transmitted according to CP-1223 standard mentioned above, there is a problem that transmitting information of one frame, which is a minimum unit of information to be transmitted, requires a relatively long time.

An object of the present disclosure is to provide a visible light communication device and the like which enable a receiving device to receive information from the visible light communication device in a shorter time.

In order to solve the above problem, according to an aspect of the present disclosure, there is provided a visible light communication device including: a light source unit configured to emit light for visible light communication; and a control circuit that generates an original signal of the light to be emitted by the light source unit, wherein the control circuit generates the original signal that includes a payload part, a Cyclic Redundancy Check (CRC) part, and a recognition part, the payload part including identification information identifying the visible light communication device, the CRC part being determined according to data indicated in the payload part, and the recognition part being arranged immediately subsequent to the CRC part.

### BRIEF DESCRIPTION OF DRAWINGS

The figures depict one or more implementations in accordance with the present teaching, by way of examples only, not by way of limitations. In the figures, like reference numerals refer to the same or similar elements.

FIG. 1 is a schematic diagram of a visible light communication system according to Embodiment 1;

FIG. 2 is a block diagram illustrating a structure of a visible light communication device according to Embodiment 1;

FIG. 3 is an explanatory diagram of a frame structure of signals transmitted by a visible light communication device according to a related art;

FIG. 4 is an explanatory diagram of a frame structure of signals transmitted by the visible light communication device according to Embodiment 1;

FIG. 5 is a schematic diagram illustrating a signal pattern of an identification signal according to Embodiment 1;

FIG. 6 is a schematic diagram of a visible light communication system according to Embodiment 2;

FIG. 7A is a block diagram illustrating a structure of a visible light communication device according to Embodiment 2;

FIG. 7B is a schematic diagram illustrating a method of identifying the visible light communication device according to Embodiment 2;

FIG. 8 is a schematic diagram of a visible light communication system according to Embodiment 3;

FIG. 9 is a schematic diagram illustrating a first structure example of a light source unit of the visible light communication device according to Embodiment 3;

FIG. 10 is a schematic diagram illustrating a second structure example of the light source unit of the visible light communication device according to Embodiment 3;

FIG. 11 is a schematic diagram illustrating a third structure example of the light source unit of the visible light communication device according to Embodiment 3;.

FIG. 12 is a schematic diagram illustrating a fourth structure example of the light source unit of the visible light communication device according to Embodiment 3;

FIG. 13 is a schematic diagram illustrating a use example of the visible light communication system according to Embodiment 3;

FIG. 14 is a schematic diagram of an automobile having, as a light, a light source unit of a visible light communication device according to Embodiment 4;

FIG. 15 is an enlarged diagram of a first example of the light source unit of the visible light communication device according to Embodiment 4; and

FIG. 16 is an enlarged diagram of a second example of the light source unit of the visible light communication device according to Embodiment 4.

### DETAILED DESCRIPTION OF THE PREFERRED EMBODIMENTS

The following describes visible light communication devices according to the embodiments of the present disclosure in detail with reference to the Drawings. It should be noted that all the embodiments described below are preferred examples of the present disclosure. Numerical values, shapes, materials, constituent elements, arrangement positions and the connection configuration of the constituent elements, and the like described in the following embodiments are merely examples. They are therefore not intended to limit the present disclosure. Therefore, among the constituent elements in the following embodiments, constituent elements that are not described in independent claims that show the most generic concept of the present disclosure are described as elements constituting more desirable configurations.

It should also be noted that these figures in the Drawings are schematic diagrams and are not necessarily exact illustrations. Furthermore, the same reference numerals are assigned to the identical constituent elements throughout the figures.

### Embodiment 1

The following describes a visible light communication device and the like according to Embodiment 1 that enable a receiving device to receive information from the visible light communication device in a shorter time.

First, the description is given for problems in visible light beacon signals as visible light communication signals defined according to CP-1223 standard described in Non-Patent Literature 1 are described. Regarding visible light beacon signals, which are visible light communication signals defined according to CP-1223 standard described in Non-Patent Literature 1, it takes approximately 33 msec to transmit and receive information of one frame. If a moving object, which moves at a high speed and is to receive a visible light beacon signal, has moved within a time of approximately 33 msec that is required to receive one frame, the moving object may fail to receive the visible light beacon signal. Furthermore, if hardware or software, which receives signals at a low speed, is to receive a visible light beacon signal, there may be problems that it takes a long time to store and process the signal received within approximately 33 msec, that a memory consumption amount and a processing load which are required for the signal processing increase, and that power consumption also increases. Therefore, it is required to transmit and receive information in a time shorter than approximately 33 msec.

Thus, an object of the present disclosure is to provide a visible light communication device and the like that transmit visible light beacon signals defined according to CP-1223 standard which an image sensor can receive in a shorter time. The reception in a shorter time can reduce a memory consumption amount and power consumption of a receiving device.

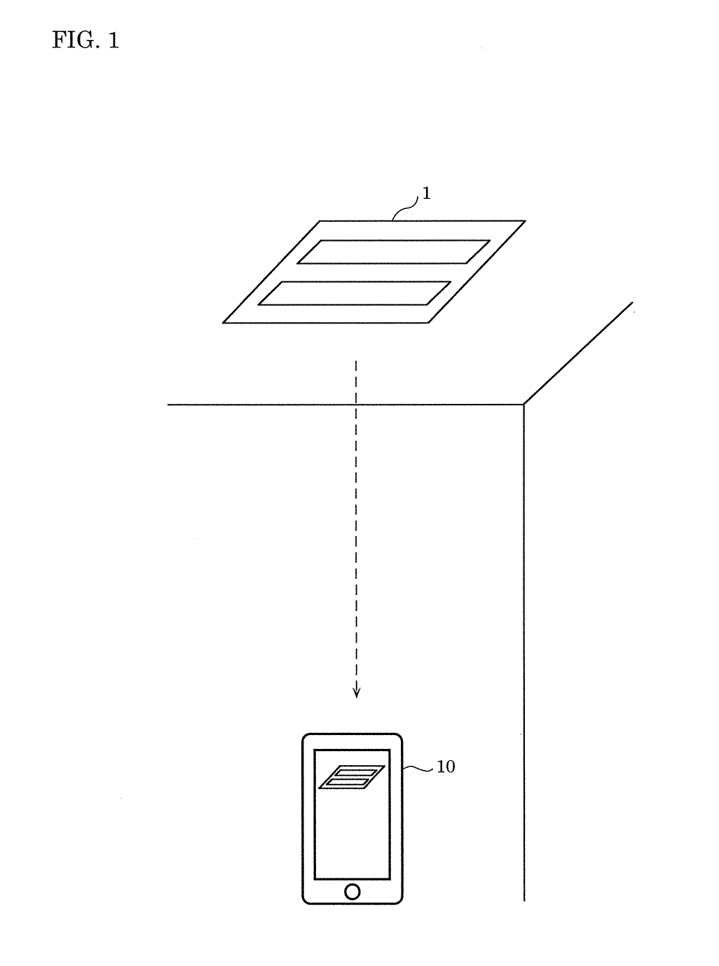

FIG. 1 is a schematic diagram of a visible light communication system according to Embodiment 1

As illustrated in FIG. 1, the visible light communication system according to Embodiment 1 includes visible light communication device 1 and receiving device 10.

Visible light communication device 1 is an illumination device that emits illumination light to the place around visible light communication device 1 to illuminate the place. The light emitted by visible light communication device 1 is illumination light (hereinafter, referred to also as “communication light”) that includes information and is transmitted to receiving device 10 by visible light communication. The communication light includes identification information uniquely identifying visible light communication device 1. The communication light serving as the identification information includes, for example, device identification information uniquely identifying visible light communication device 1 or position information indicating a position of visible light communication device 1. Devices that receive the communication light can identify visible light communication device 1 based on the information included in the communication light. An example of visible light communication device 1 is an illumination device having a Light Emitting Diode (LED) as a light source.

Receiving device 10 receives communication light emitted by visible light communication device 1 to receive information from visible light communication device 1. Receiving device 10 receives the above-described communication light by using an image sensor or the like and obtains the identification information included in the received communication light, thereby identifying visible light communication device 1. Receiving device 10 is implemented to a portable telephone terminal, a smartphone (high-functioning portable telephone terminal), a tablet, a Personal Computer (PC), or the like.

In other words, receiving device 10 is a receiving device for visible light communication, and includes a light receiver that receives light from visible light communication device 1; and a control circuit that extracts an original signal of the light received by the light receiver. The control circuit obtains a recognition part from the original signal, and obtains a CRC part arranged immediately prior to the obtained recognition part from the original signal as a signal for identifying visible light communication device 1. The light receiver and the control circuit perform operations opposite to those performed by light source unit 20 and signal control circuit 30 described later, respectively, in visible light communication device 1.

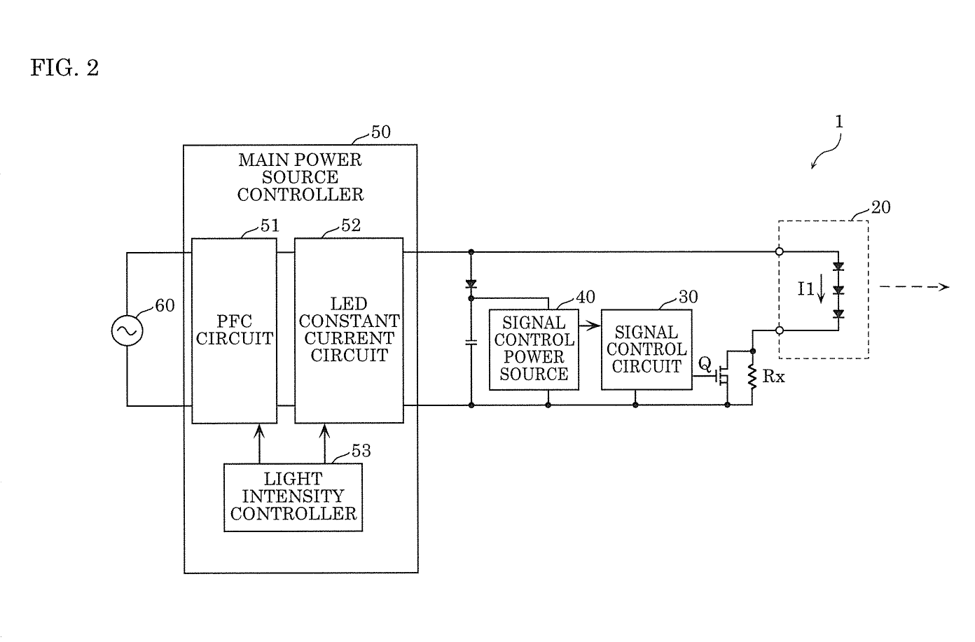

FIG. 2 is a block diagram illustrating a structure of visible light communication device 1 according to Embodiment 1.

As illustrated in FIG. 2, visible light communication device 1 includes light source unit 20, signal control circuit 30, signal control power source 40, and main power source controller 50.

Light source unit 20 is a self-emitting light source that emits communication light including information to be transmitted to receiving device 10 by visible light communication. Light source unit 20 emits the communication light by being turned ON and OFF according to input current I1. The communication light emitted by light source unit 20 is received by receiving device 10. Light source unit 20 is, for example, an LED, an organic Electro-Luminescence (EL), or the like. Hereinafter, it is assumed that light source unit 20 is an LED.

Signal control circuit 30 is a control circuit that generates an original signal of communication light to be emitted by light source unit 20. Signal control circuit 30 adjusts (modulates) a value of current I1 to generate an electrical signal (hereinafter, referred to also as an “original signal”) corresponding to a signal included in communication light to be emitted by light source unit 20. More specifically, signal control circuit 30 generates an electrical signal having an amplitude varying depending on variation of the intensity of communication light to be emitted by light source unit 20. Signal control circuit 30 is connected to switching element Q (for example, Metal-Oxide-Semiconductor Field-Effect Transistor (MOSFET)) and controls current I1.

Signal control circuit 30 generates an original signal including information to be transmitted to receiving device 10, and light source unit 20 emits communication light generated from the original signal including the information, so that visible light communication device 1 transmits the information to receiving device 10. The information included in an original signal is described in more detail later.

Signal control power source 40 is a power source circuit that drives signal control circuit 30. Signal control power source 40 receives power from main power source controller 50, thereby generates a voltage for driving signal control circuit 30, and then applies the resulting voltage to signal control circuit 30.

Main power source controller 50 is a power source circuit that receives power from external power source 60 and thereby supplies power to light source unit 20, signal control power source 40, and the like. Main power source controller 50 includes Power Factor Correction (PFC) circuit 51 (power factor corrector) and LED constant current circuit 52 to generate constant current for driving the LED. Furthermore, light intensity controller 53 adjusts an amount of the constant current.

The following describes information included in communication light emitted by visible light communication device 1.

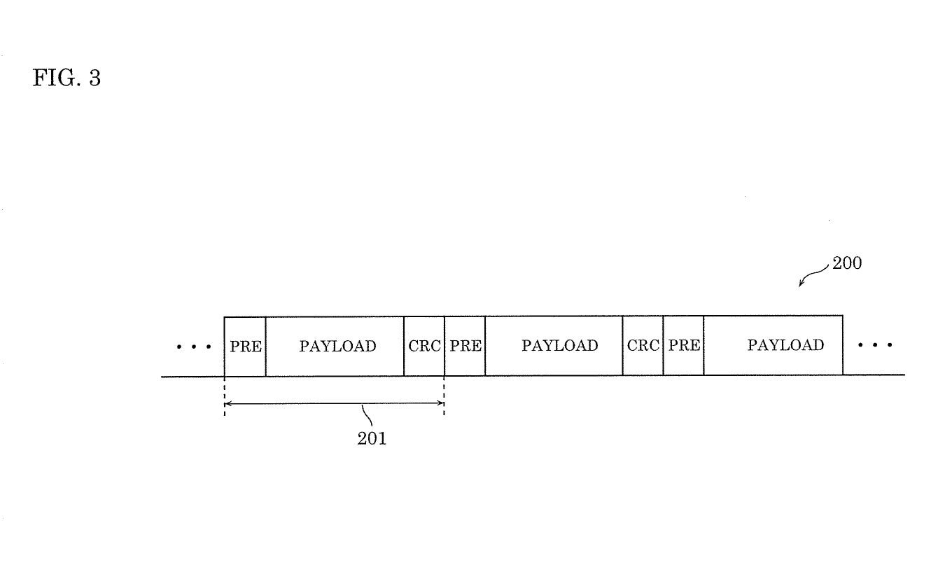

FIG. 3 is an explanatory diagram of a frame structure of a signal transmitted by a visible light communication device according to a related art. More specifically, the related art is the technique related to visible light beacon signals defined according to CP-1223 standard, which is disclosed in Non-Patent Literature 1. FIG. 3 illustrates an original signal of communication light. Since communication light is generated from this original signal and transmitted, the signal illustrated in FIG. 3 can be considered as being equivalent to information included in communication light.

FIG. 3 illustrates frame sequence 200 including a plurality of frames of a visible light beacon signal. Frame sequence 200 includes frame 201 that is one of frames in a visible light beacon signal defined according to CP-1223 standard.

Frame 201 includes parts: a preamble (PRE), a payload (PAYLOAD), and a Cyclic Redundancy Check (CRC). The parts are referred to also as “fields”.

The preamble is a field that is determined according to CP-1223 standard and has a predetermined pattern for indicating a start position of the frame. In order to distinguish the preamble from the other fields in frame 201, the preamble has a pattern that cannot be generated by coding according to 4-ary Pulse Position Modulation (4PPM) coding rule, in other words, a pattern not complying with 4PPM coding rule. The preamble has a time length of, for example, 12 slots.

Here, a slot is a minimum unit of a time period required to emit light having a certain intensity. According to CP-1223 standard, one slot is defined as 0.104 msec. Furthermore, the simple expression of “time length” means a time period required to transmit a target signal.

A payload is a field including information that is included in frame 201 and transmitted to receiving device 10. A payload includes identification information uniquely identifying visible light communication device 1. A payload is coded according to 4PPM coding rule. A payload has, for example, 128 bits (256 slots).

CRC is a field including a code used in detecting an receiving error of receiving device 10. More specifically, receiving device 10 that receives frame 201 calculates CRC in the same manner as described above, and if the calculated CRC matches the CRC included in frame 201, receiving device 10 determines that frame 201 has been received successfully, in other words, without error. CRC has, for example, 16 bits (32 slots).

CRC indicates a value that is calculated from a predetermined field including a payload according to a predetermined generator polynomial for generating CRC. If a plurality of frames have identical predetermined fields (hereinafter, referred to as a “CRC target field”) including a payload, the frames have identical CRCs calculated from respective CRC target fields. On the other hand, if a plurality of frames have different data of CRC target fields, the frames generally have different calculated CRCs but sometimes have identical calculated CRCs.

When frame 201 having the above-described length is included in communication light and then transmitted, the transmission takes, for example, approximately 33 msec.

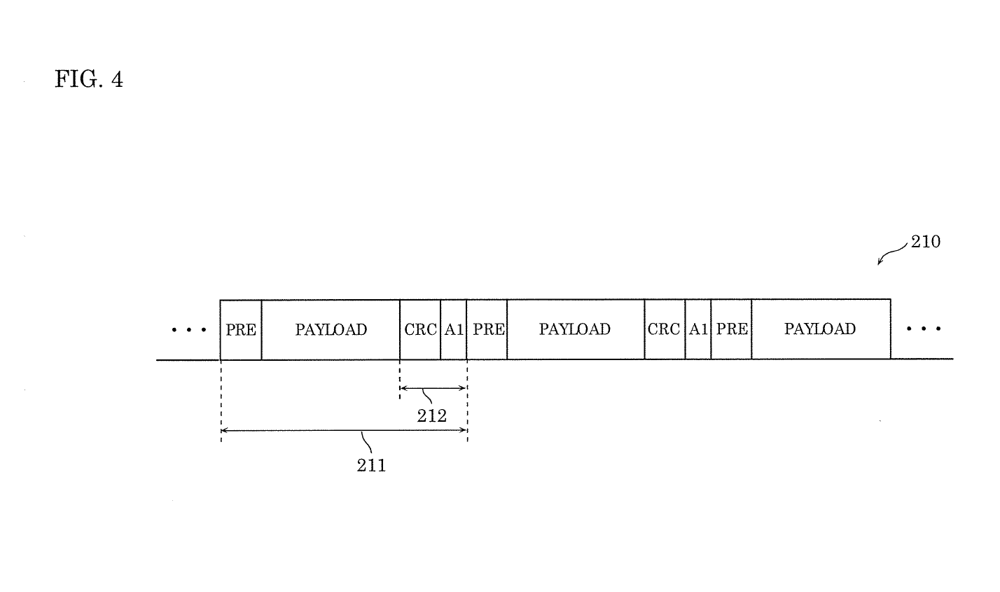

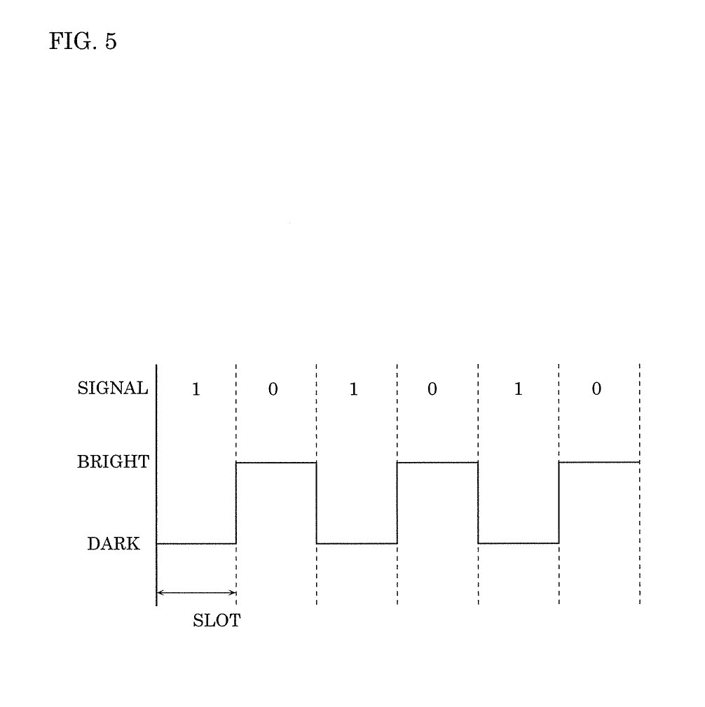

FIG. 4 is an explanatory diagram of a frame structure of a signal transmitted by visible light communication device 1 according to Embodiment 1. FIG. 5 is a schematic diagram illustrating a signal pattern of an identification signal according to Embodiment 1. Referring to FIGS. 4 and 5, the frame structure of communication light according to Embodiment 1 is described.

FIG. 4 illustrates an original signal of communication light generated by signal control circuit 30, and information included in the communication light. More specifically, FIG. 4 illustrates frame sequence 210 including a series of frames 211 of a visible light beacon signal.

Frame 211 includes fields: a preamble (PRE), a payload (PAYLOAD), a CRC, and an A1. The fields of the preamble (PRE), the payload (PAYLOAD), and CRC are the same as those described according to the related art and therefore not explained again.

A1 is a field arranged immediately subsequent to CRC in an original signal, and indicates a position of CRC. A1 may be any field having the above-described characteristics. In receiving communication light including A1, receiving device 10 can determine, as CRC, a field having a predetermined length and arranged immediately prior to A1 in the communication light.

A1 may be a filed having a predetermined fixed pattern. A1 has the pattern, for example, as illustrated in FIG. 5. A1 illustrated in FIG. 5 is a signal having 6 slots “101010”. Here, a signal of “1” indicates a “dark” state (the state where the light source does not emit light), while a signal of “0” indicates a “bright” state (the state where the light source emits light). In this case, A1 has a pattern not complying with 4PPM coding rule. Since A1 does not comply with 4PPM coding rule, there are advantages that A1 can be easily distinguished from the other fields in frame 211.

Furthermore, A1 may be any field having a pattern that temporally varies. In this case, it is necessary to define, between visible light communication device 1 and receiving device 10, how to temporally vary A1. A1 may be a field shorter than a preamble. For example, A1 may have 4 bits (8 slots). Furthermore, A1 may have any other length that is shorter than a preamble.

When frame 211 having the above-described length is included in communication light to be transmitted, the transmission takes, for example, approximately 34 msec. However, receiving device 10 can obtain information from frame 211 in a shorter time than approximately 34 msec, as described below.

More specifically, receiving device 10 receives transmitted communication light, and thereby obtains frame sequence 210 included in received communication light Then, if receiving device 10 analyzes frame sequence 210 and finds a predetermined pattern of A1, receiving device 10 obtains the found A1 field. Since A1 has a pattern not complying with 4PPM coding rule, it is easy to find A1 field.

If receiving device 10 finds A1 in obtained frame 211, receiving device 10 obtains a field having a length of CRC which is arranged immediately prior to A1, thereby obtaining CRC from obtained frame sequence 210.

CRC obtained by receiving device 10 has been calculated from data in a CRC target field including a payload in frame 211. In most cases, different CRCs are calculated from frames 211 having different payloads, as described above. Therefore, receiving device 10 can use CRC instead of identification information as unique information included in frame 211.

As described above, in order to obtain information from communication light by using CRC and A1, receiving device 10 needs to receive only part 212 that includes CRC and A1 in frame 211, which takes a time of, for example, approximately 3.3 msec. This time is approximately one tenth of a time required for reception of frame 201 in FIG. 3. Therefore, the time required to receive frame 211 is much shorter than the time required to receive frame 201.

In other words, the use of A1 as a landmark to find CRC enables receiving device 10 to find CRC from frame 211 in a shorter time.

On the other hand, as described previously, identical CRCs may be calculated from two or more frames having different data of CRC target fields. If two or more frames are transmitted from two or more different visible light communication devices, receiving device 10 cannot distinguish between the two or more visible light communication devices by the method using CRC and A1.

However, since CRC is generated according to a predetermined generator polynomial, it is possible, when pieces of data of CRC target fields are certain, to determine whether or not there is a risk that identical CRCs would be calculated from two or more frames. If there is such a risk, it is possible to adjust data of a payload included in a frame or change a position of the visible light communication device in order to avoid the risk.

As described above, visible light communication device 1 according to Embodiment 1 includes: light source unit 20 that emits light for visible light communication; and signal control circuit 30 that generates an original signal of the light to be emitted by light source unit 20. Signal control circuit 30 generates the original signal that includes a payload part, a Cyclic Redundancy Check (CRC) part, and a recognition part. The payload part includes identification information identifying visible light communication device 1. The CRC part is determined according to data indicated in the payload part. The recognition part is arranged immediately subsequent to the CRC part.

This structure allows visible light communication device 1 to enable the receiving device to find the CRC part from the original signal based on the recognition part. Since the CRC part is generated according to the identification information, receiving device 10 can identify visible light communication device 1 based on the CRC part. Thus, receiving device 10 can identify visible light communication device 1 by using the recognition part and the CRC part. As a result, receiving device 10 can identify visible light communication device 1 in a shorter time in comparison to identification by using the payload part and the CRC part. Therefore, visible light communication device 1 enables receiving device 10 to receive information in a shorter time.

It is also possible that the recognition part is shorter than a preamble part arranged immediately prior to the payload part.

This structure allows visible light communication device 1 to enable receiving device 10 to find the identification part by using the recognition part that is shorter than the preamble part. As a result, visible light communication device 1 enables receiving device 10 to receive information in a shorter time.

It is further possible that the recognition part has a predetermined fixed signal pattern.

This structure allows visible light communication device 1 to enable receiving device 10 to find a signal having a predetermined pattern and thereby find the recognition part. As a result, visible light communication device 1 enables receiving device 10 to receive information by simpler processing. It is still further possible that the recognition part has a pattern not complying with 4-ary Pulse Position Modulation (4PPM) coding rule of CP-1223 standard.

This structure allows visible light communication device 1 to enable receiving device 10 to find the recognition part by using a signal not complying with a coding rule that is applied to the payload part and the CRC part. As a result, visible light communication device 1 enables receiving device 10 to receive information by simpler processing.

It is still further possible that the recognition part is a signal that enables receiving device 10 receiving the light to find the CRC part arranged immediately prior to the recognition part and identify visible light communication device 1 by using the CRC part.

This structure enables receiving device 10 to find the recognition part, obtain the CRC part based on the found recognition part, and eventually identify visible light communication device 1 by using the CRC part. As a result, receiving device 10 can receive information from visible light communication device 1 in a shorter time.

Furthermore, receiving device 10 according to the present embodiment is a receiving device for visible light communication, and includes: a light receiver that receives light from visible light communication device 1; and a control circuit that extracts an original signal of the light received by the light receiver. The control circuit obtains a recognition part from the original signal, and obtains a CRC part arranged immediately prior to the obtained recognition part from the original signal as a signal for identifying visible light communication device 1.

This structure produces the same effects as described above.

### Embodiment 2

In Embodiment 2, a visible light communication system enabling a receiving device to identify more visible light communication devices is described.

It should be noted that the same reference numerals in Embodiment 1 are assigned to identical functional blocks and the like in Embodiment 2, so that the explanation of the identical functional blocks and the like is not repeated below.

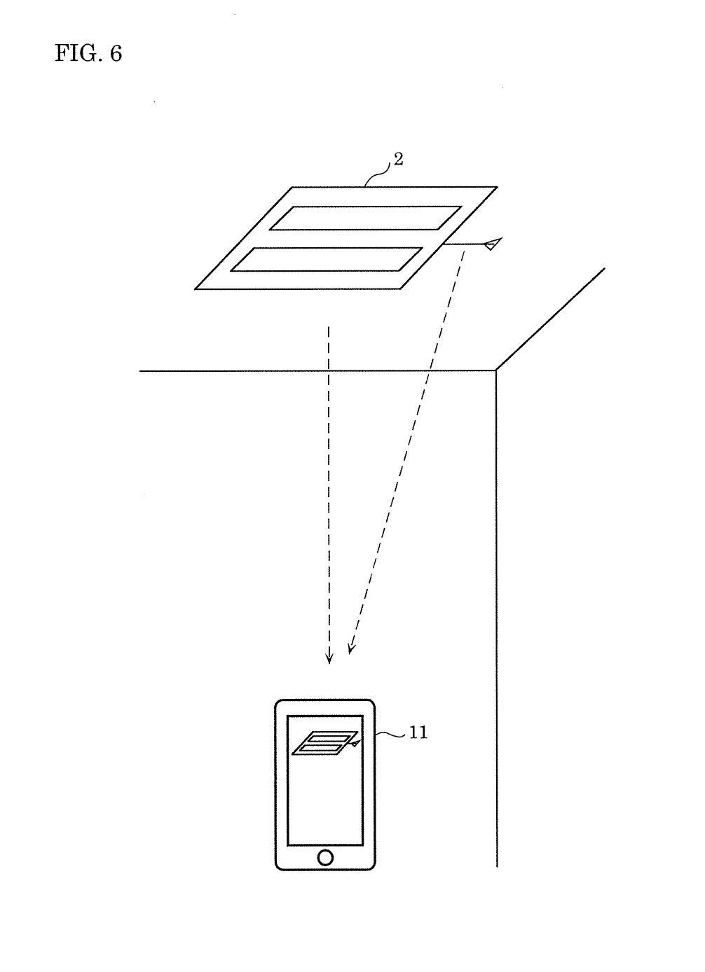

FIG. 6 is a schematic diagram of a visible light communication system according to Embodiment 2.

As illustrated in FIG. 6, the visible light communication system according to Embodiment 2 includes one or more visible light communication devices 2 and receiving device 11.

In the similar manner of visible light communication device 1 according to Embodiment 1, each visible light communication device 2 emits communication light including identification information (referred to also as “first identification information”) identifying visible light communication device 2 itself, and transmits a radio beacon including second identification information different from the first identification information.

Visible light communication device 2 repeatedly transmits a radio beacon to the place around visible light communication device 2. The radio beacon includes the second identification information that is used with the first identification information included in the communication light to identify visible light communication device 2.

More specifically, if there are a plurality of visible light communication devices 2, visible light communication devices 2 transmit different pieces of first identification information and different pieces of second identification information, so that the pieces of first identification information transmitted by different visible light communication devices 2 are not identical and the pieces of second identification information transmitted by different visible light communication devices 2 are not identical. In other words, visible light communication device 2 is capable of emitting communication light including first identification information that is different from pieces of first identification information emitted by other visible light communication devices 2, and transmitting a radio beacon including the second identification information that is identical to pieces of second identification information emitted by other visible light communication devices 2. It is also possible that visible light communication device 2 is capable of emitting communication light including first identification information that is identical to pieces of first identification information emitted by other visible light communication devices 2, and transmitting a radio beacon including the second identification information that is different from pieces of second identification information emitted by other visible light communication devices 2.

Receiving device 11 has the same function as that of receiving device 10 according to Embodiment 1, and also a function of receiving radio beacons.

Receiving device 11 receives both communication light and a radio beacon from visible light communication device 2. Receiving device 11 obtains identification information included in the communication light and identification information included in the radio beacon, and thereby identifies visible light communication device 2 by using these pieces of identification information.

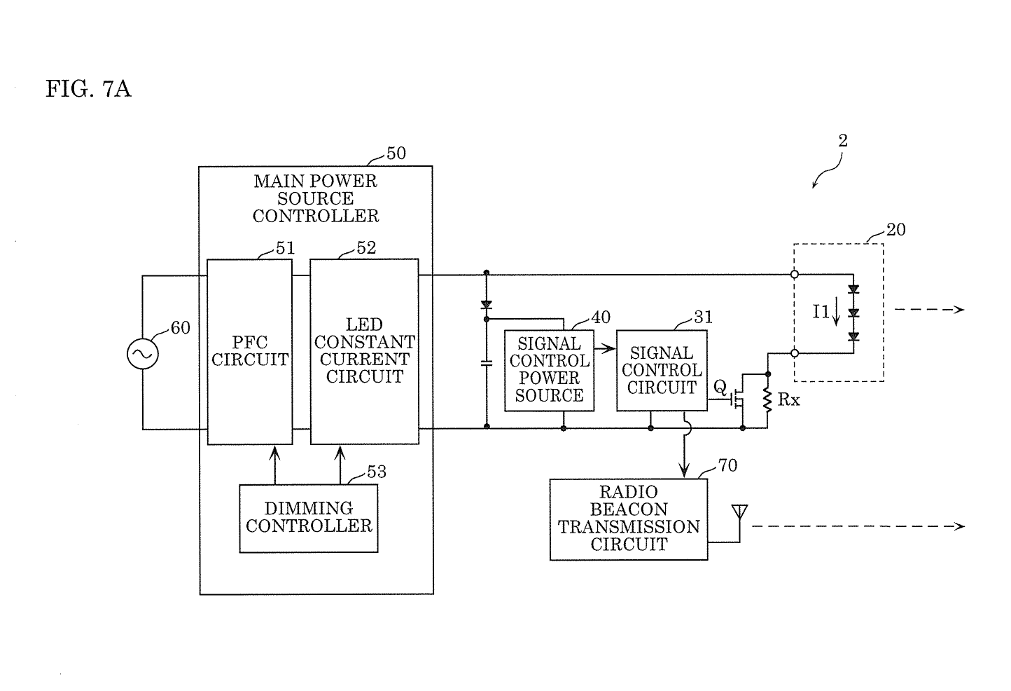

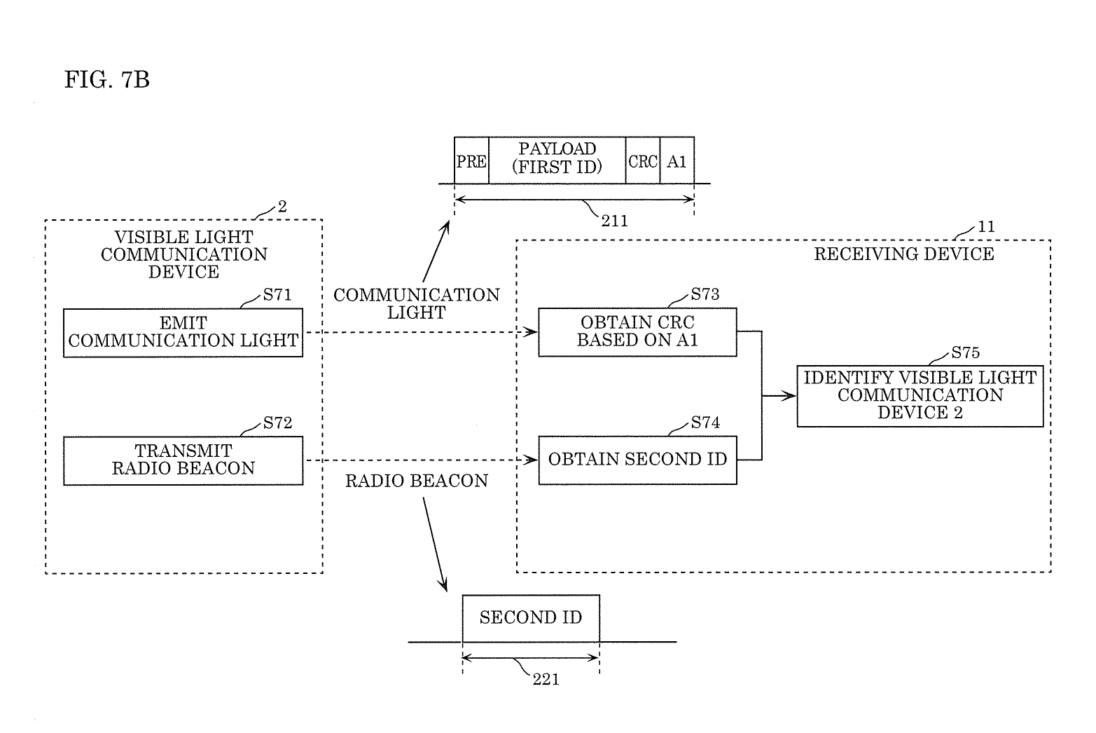

FIG. 7A is a block diagram illustrating a structure of visible light communication device 2 according to Embodiment 2.

As illustrated in FIG. 7A, visible light communication device 2 includes light source unit 20, signal control circuit 31, signal control power source 40, main power source controller 50, and radio beacon transmission circuit 70. Here, light source unit 20, signal control power source 40, and main power source controller 50 are the same as those described in Embodiment 1.

Signal control circuit 31 is a control circuit that generates an original signal of communication light to be emitted by light source unit 20, in the same manner as signal control circuit 30 according to Embodiment 1. Furthermore, signal control circuit 31 generates an identification signal to be included in a radio beacon and provides the generated identification signal to radio beacon transmission circuit 70.

Signal control circuit 31 generates an original signal including a part of the identification information to be transmitted to receiving device 10, and provides the generated original signal to light source unit 20. In addition, signal control circuit 31 generates a signal including the remaining part of the identification information, and causes radio beacon transmission circuit 70 to transmit the generated signal.

Radio beacon transmission circuit 70 is a transmission circuit that transmits a radio beacon including identification information of visible light communication device 2. Radio beacon transmission circuit 70 obtains the identification information outputted from signal control circuit 31, and transmits a radio beacon including the obtained identification information to the place around visible light communication device 2. The transmitted radio beacon is received by receiving device 10.

FIG. 7B is a schematic diagram illustrating a method of identifying visible light communication device 2 according to Embodiment 2.

As illustrated in FIG. 7B, at Step S71, visible light communication device 2 emits communication light including first identification information. The communication light includes frame 201. More specifically, the communication light includes: a payload including the first identification information; CRC calculated from a CRC target field including the payload; and A1 arranged immediately subsequent to CRC.

At Step S72, visible light communication device 2 transmits a radio beacon including second identification information 221.

At Step S73, receiving device 11 receives the communication light from visible light communication device 2. In receiving the communication light, receiving device 11 obtains CRC from the communication light based on A1 by the same method as described in Embodiment 1.

At Step S74, receiving device 11 receives a radio beacon from visible light communication device 2. In receiving the radio beacon, receiving device 11 obtains second identification information 221 included in the radio beacon. At Step S75, receiving device 11 identifies visible light communication device 2 by using CRC obtained at Step S73 and second identification information 221 obtained at Step S74.

As described above, receiving device 11 can identify visible light communication device 2 by using CRC included in the communication light and the second identification information included in the radio beacon. As described in Embodiment 1, there is a risk that CRCs included in communication lights transmitted from two or more different visible light communication devices are identical. In order to avoid the risk, the two or more visible light communication devices transmit radio beacons having different pieces of second identification information, so that receiving device 11 can distinguish between the two or more visible light communication devices.

As described above, visible light communication device 2 according to Embodiment 2 further includes radio beacon transmission circuit 70 that transmits a signal by radio waves. Signal control circuit 31 in visible light communication device 2 generates (a) an original signal including a part of identification information and (b) a signal including a remaining part of the identification information, and causes radio beacon transmission circuit 70 to transmit (b) the generated signal including the remaining part.

This structure allows visible light communication device 2 to transmit information to receiving device 11 by using both visible light communication and a radio beacon. Receiving device 11 identifies visible light communication device 2 by using a recognition part and a CRC part in visible light communication. Therefore, receiving device 11 can identify visible light communication device 2 in a shorter time in comparison to identification by using a payload part and a CRC part. Furthermore, receiving device 11 receives information by visible light communication and receives information by a radio beacon. Therefore, receiving device 11 obtains pieces of identification information from both the visible light and the radio beacon. As a result, receiving device 11 can obtain a more amount of identification information.

### Embodiment 3

In Embodiment 3, the description is given for a visible light communication system that enables a receiving device to more surely receive communication light from a visible light communication device.

Some light sources of conventional visible light communication devices have a relatively small light-emitting area, such as a light-emitting area of a light-bulb type light source. In this case, such a light source needs to emit light having a relatively high intensity to illuminate the place around the visible light communication device.

On the other hand, a receiving device used in visible light communication generally uses an image sensor for receiving communication light. An image sensor has characteristics that a sensor value is saturated (in other words, a certain value is outputted regardless of the intensity of received light) when light having a higher intensity than a predetermined intensity is received. Therefore, in a part of the image sensor, which receives light having a high intensity, a sensor value is saturated. Therefore, the receiving device fails to detect brightness of the communication light and cannot obtain information by visible light communication.

The visible light communication device according to Embodiment 3 enables a receiving device to more surely receive communication light from the visible light communication device, even if an area of a light source of the receiving device is relatively small.

It should be noted that the visible light communication device according to Embodiment 3 may be implemented to be different from visible light communication device 1 according to Embodiment 1, as a visible light communication device enabling a receiving device to more surely receive communication light from the visible light communication device.

It should be noted that the same reference numerals in Embodiments 1 and 2 are assigned to identical functional blocks and the like in Embodiment 3, so that the explanation of the identical functional blocks and the like is not repeated below.

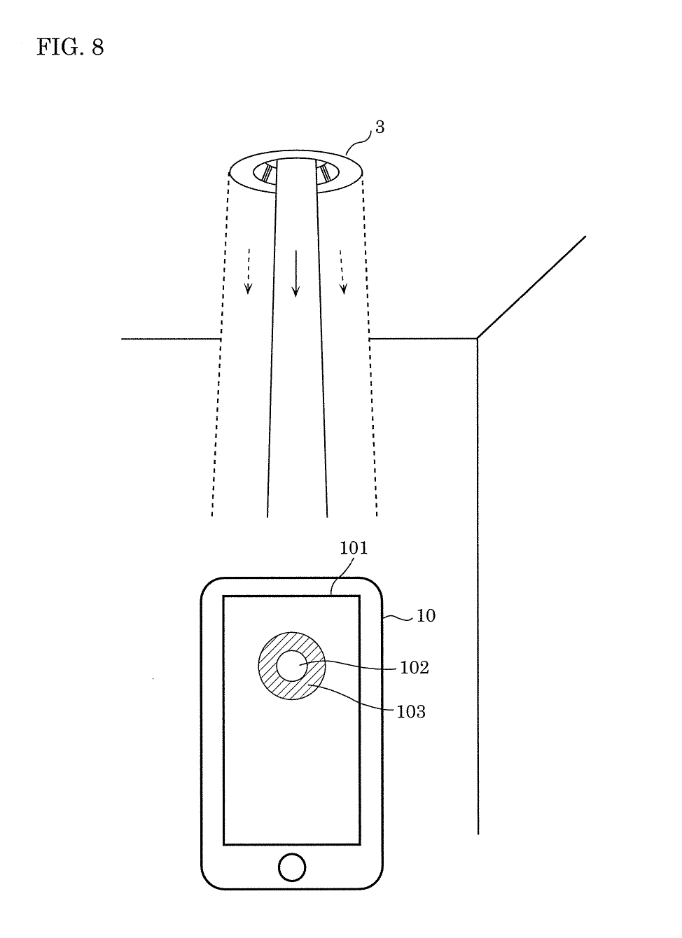

FIG. 8 is a schematic diagram of a visible light communication system according to Embodiment 3.

As illustrated in FIG. 8, the visible light communication system according to Embodiment 3 includes visible light communication device 3 and receiving device 10.

Visible light communication device 3 emits communication light including identification information of visible light communication device 3, in the same manner as visible light communication device 1 according to Embodiment 1. Visible light communication device 3 has a light source which emits light having high luminance and a relatively high intensity from a relatively small light-emitting region.

The communication light emitted by visible light communication device 3 includes: communication light (hereinafter, referred to also as “main communication light” or “first light”) that is emitted by a light source and incident directly on receiving device 10; and communication light (hereinafter, referred to as “sub communication light” or “second light”) having a lower intensity than the intensity of the main communication light. The low intensity of sub communication light enables receiving device 10 to more surely receive the sub communication light. Here, the expression “incident directly on” means that light arrives at receiving device 10 without being reflected or refracted on/by an object. It should be noted that the light-emitting region has a first light-emitting region from which the main communication light is emitted and a second light-emitting region from which the sub communication light is emitted.

Although FIG. 8 illustrates that the second light-emitting region surrounds the entire periphery of the first light-emitting region, the arrangement of the first light-emitting region and the second light-emitting region is not limited to this example. The first light-emitting region and the second light-emitting region may be arranged in any way enabling receiving device 10 to receive both light emitted from the first light-emitting region and light emitted from the second light-emitting region. More specifically, it is also possible that the second light-emitting region is arranged to surround only a part of the periphery of the first light-emitting region, or that the first light-emitting region and the second light-emitting region are arranged side by side.

Receiving device 10 receives communication light emitted by visible light communication device 3. Here, receiving device 10 receives main communication light and sub communication light as communication light.

Receiving device 10 uses an image sensor for receiving the communication light. As described above, part 102 of the image sensor, which receives the main communication light, cannot detect brightness of the communication light due to saturation of a sensor value.

On the other hand, part 103 is a part of a display screen and corresponds to a part receiving sub communication light on the image sensor. Since the sub communication light has a lower intensity than the intensity causing sensor value saturation, part 103 receiving the sub communication light is seen in a darker color than a color of part 102, expressing a degree of brightness of the sub communication light. Receiving device 10 can obtain an original signal of the communication light via part 103. Therefore, receiving device 10 can obtain information from visible light communication device 3, if receiving device 10 receives at least sub communication light.

FIG. 9 is a schematic diagram illustrating a first structure example of a light source unit of visible light communication device 3 according to Embodiment 3.

As illustrated in FIG. 9, visible light communication device 3 includes light source 301, reflective plate 302, and light guide plate 303, which form light source unit 20.

Light source 301 is a self-emitting light source that emits light. Light source 301 is implemented to, for example, an LED, an organic EL, or the like. A part of light emitted by light source 301 is reflected on reflective plate 302. The other part of the light emitted by light source 301 is emitted to the place around visible light communication device 3 and received directly by receiving device 10. Such light received by receiving device 10 corresponds to main communication light. Light emitted by light source 301 has an intensity enough to illuminate the place around visible light communication device 3. Therefore, when light emitted by light source 301 is received directly by the image sensor of receiving device 10, a sensor value of the image sensor is saturated. Here, light source 301 corresponds to the first light-emitting region.

Reflective plate 302 reflects a part of the light emitted by light source 301. When receiving the part of light emitted by light source 301, reflective plate 302 reflects the received part of light. A part of the reflected light is incident on light guide plate 303, while the remaining part of the reflected light is emitted to the place around visible light communication device 3. Reflective plate 302 has a specular surface or a mirror finished surface.

Light guide plate 303 receives light emitted directly from light source 301 or light reflected on reflective plate 302, and diffuse the received light inside light guide plate 303 to emit the resulting homogeneous light from the surface of light guide plate 303. Light guide plate 303 decreases the intensity of the light received from light source 301 or reflective plate 302 to be emitted. The light emitted from light guide plate 303 corresponds to the sub communication light. It should be noted that light guide plate 303 corresponds to the second light-emitting region.

Light source unit 20 having the structure illustrated in FIG. 9 is capable of emitting communication light including main communication light and sub communication light from one self-emitting light source 301. Receiving device 10 is capable of receiving, by the image sensor, communication light emitted by light source unit 20, and obtaining an original signal from sub communication light included in the received communication light.

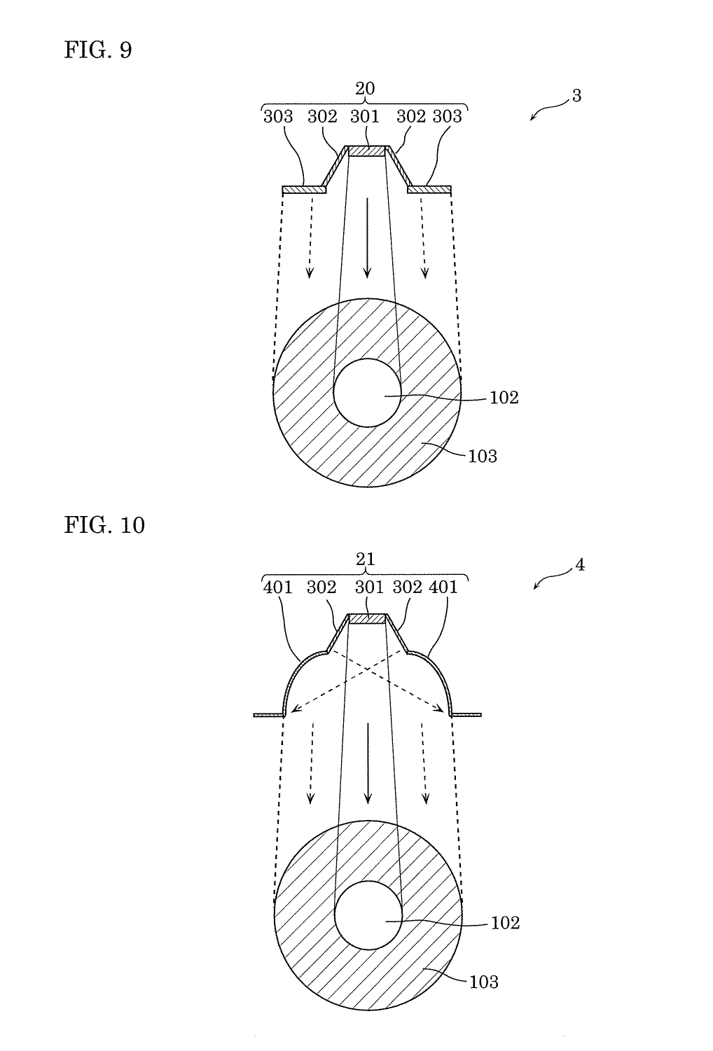

FIG. 10 is a schematic diagram illustrating a second structure example of the light source unit of the visible light communication device according to Embodiment 3.

As illustrated in FIG. 10, visible light communication device 4 includes light source 301, reflective plate 302, and diffuse reflective plate 401, which form light source unit 21. Light source 301 and reflective plate 302 are the same as those in light source unit 20 in FIG. 9.

Diffuse reflective plate 401 receives light emitted directly from light source 301 or light reflected on reflective plate 302, and diffusely reflects the received light. Diffuse reflective plate 401 decreases the intensity of the light received from light source 301 or reflective plate 302 to be emitted. The light emitted from diffuse reflective plate 401 corresponds to the sub communication light. It should be noted that diffuse reflective plate 401 has a surface applied with processing, such as emboss processing, more specifically, satin finish processing. Here, diffuse reflective plate 401 corresponds to the second light-emitting region.

Light source unit 21 having the structure illustrated in FIG. 10 produces the same effects as those of light source unit 20 illustrated in FIG. 9.

FIG. 11 is a schematic diagram illustrating a third structural example of the light source unit of the visible light communication device according to Embodiment 3.

As illustrated in FIG. 11, visible light communication device 5 includes light source 301, reflective plate 302, and diffuse reflective plate 501, which form light source unit 22. Light source 301 and reflective plate 302 are the same as those in light source unit 20 in FIG. 9.

Light source 501 is a self-emitting light source that emits light. light source 501 emits, from the surface, light having lower luminance than luminance of light source 301. Light emitted by light source 501 is generated from the same original signal as that of light source 301. The light emitted from diffuse reflective plate 501 corresponds to the sub communication light. Light source 501 is implemented to, for example, an LED.

Light source unit 22 having the structure illustrated in FIG. 11 produces the same effects as those of light source unit 20 illustrated in FIG. 9. In the example of FIG. 11, at least light emitted by light source 501 needs to include identification information and the like, and light (main communication light) emitted by light source 301 does not need to include the identification information and the like. This is because receiving device 10 can obtain the identification information and the like from light emitted by light source 501 (sub communication light), and cannot obtain the identification information and the like from main communication light emitted by light source 301 (main communication light).

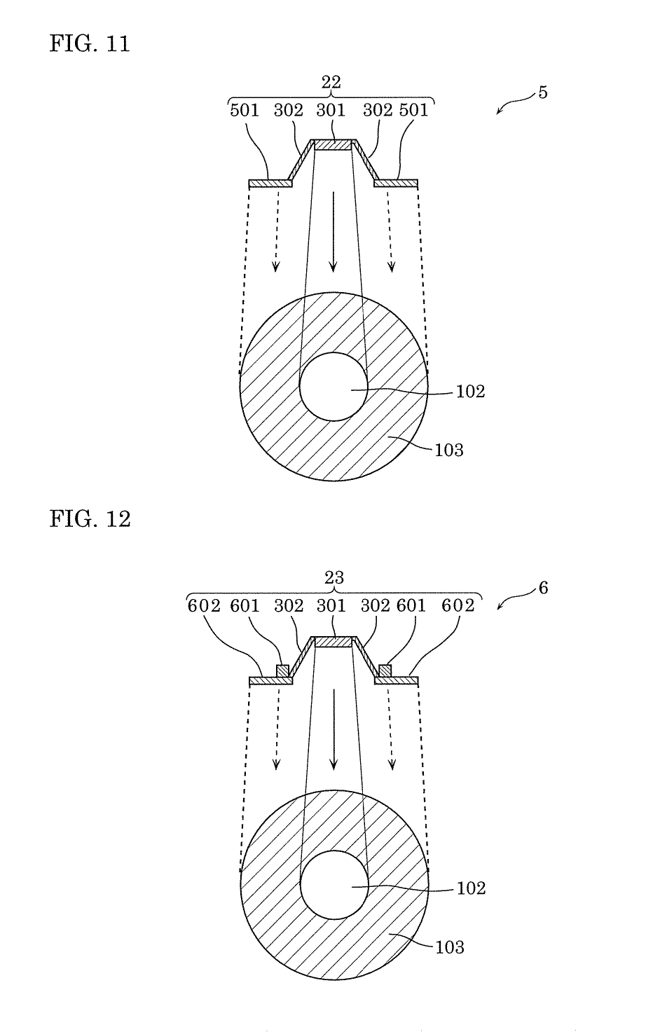

FIG. 12 is a schematic diagram illustrating a fourth structural example of the light source unit of the visible light communication device according to Embodiment 3.

As illustrated in FIG. 12, visible light communication device 6 includes light source 301, reflective plate 302, light source 601, and light guide plate 602, which form light source unit 23. Light source 301 and reflective plate 302 are the same as those in light source unit 20 in FIG. 9.

Light source 601 is a self-emitting light source that emits light. Light emitted by light source 601 is generated from the same original signal as that of light source 301. Light source 601 is implemented to, for example, an LED.

Light guide plate 602 receives light emitted directly from light source 301 or light reflected on reflective plate 302, and diffuses the received light inside light guide plate 602 to emit the resulting homogeneous light emitted from the surface of light guide plate 602. Light guide plate 602 is the same as light guide plate 303 in FIG. 9.

Light source unit 23 having the structure illustrated in FIG. 12 produces the same effects as those of light source unit 20 illustrated in FIG. 9.

In the example of FIG. 12, like light source unit 24, at least light emitted by light guide plate 602 (sub communication light) needs to include identification information and the like.

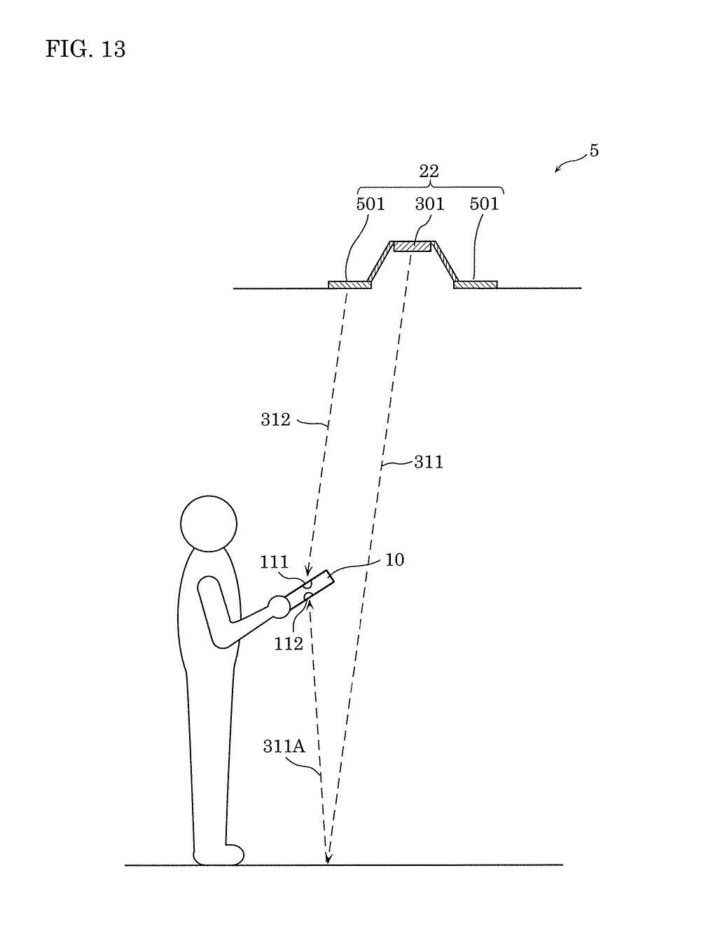

FIG. 13 is a schematic diagram illustrating a use example of a visible light communication system according to Embodiment 3.

FIG. 13 explains the configuration in which receiving device 10 receives communication light from visible light communication device 5 illustrated in FIG. 11.

Light source unit 22 of visible light communication device 5 emits main communication light 311 and sub communication light 312. Main communication light 311 is communication light that is emitted from light source 301 and directly incident on receiving device 10 to be received. Sub communication light 312 is communication light emitted from light source 501.

Receiving device 10 is assumed to have a front face and a rear face. The front face has a display screen and the like. A user often browses the front face in general use. The rear face is a surface opposite to the front face. Receiving device 10 has image sensor 111 on the front face, and image sensor 112 on the rear face.

In general use where the user is standing, image sensor 111 faces a ceiling. Therefore, image sensor 111 receives sub communication light 312 without saturation of a sensor value. Furthermore, image sensor 111 receives main communication light 311 but cannot obtain identification information and the like from main communication light 311, due to saturation of a sensor value caused by a high light intensity.

On the other hand, image sensor 112 faces a floor. Main communication light 311 is diffusely reflected on the floor surface. If the light reflected on the floor surface has an appropriate intensity, image sensor 112 can receive main communication light 311A reflected on the floor surface without saturation of a sensor value. On the other hand, although sub communication light 312 is also diffusely reflected on the floor surface, the intensity of sub communication light 312 is lower than the intensity of main communication light 311. Therefore, it is more difficult to cause the sub communication light (not illustrated) reflected on the floor surface to have an appropriate intensity, in comparison to the case of main communication light 311.

As described above, receiving device 10 is capable of receiving by image sensor 112 main communication light 311 emitted by visible light communication device 3 and also receiving by image sensor 111 sub communication light 312.

In particular, as illustrated in FIGS. 11 and 12, if main communication light and sub communication light include different original signals, the main communication light and the sub communication light are used to transmit information from the visible light communication device to a receiving device by two ways.

Although the structures of the light source unit according to Embodiment 3 have been described as the same as that of the light source unit according to Embodiment 1 or 2, the structure of the light source unit is not limited to the example. In other words, the light source unit according to Embodiment 3 may be applied to light source units in other visible light communication devices.

As described above, in visible light communication device 3 and the like according to Embodiment 3, the light includes (a) first light having a predetermined intensity and (b) second light having a lower intensity than the predetermined intensity of the first light. Light source unit 20 or the like includes a first light-emitting region and a second light-emitting region. The first light-emitting region emits the first light, and the second light-emitting region emits the second light and is different from the first light-emitting region.

This structure allows each of visible light communication device 3 and the like to illuminate the place around the visible light communication device by the first light (main communication light) and transmit information by the second light (sub communication light). In this case, each of visible light communication device 3 and the like can emit the two kinds of light which are generated from light emitted from the same light source. Therefore, each of visible light communication device 3 and the like is capable of illuminating the place around the visible light communication device and of causing a receiving device to more surely receive communication light.

It is also possible that the first light-emitting region is a region including a light source that emits the first light, and the second light-emitting region is a region including a light guide plate that receives the first light from the light source, internally diffuses the first light received to emit second light from a surface of the light guide plate.

This structure allows, in more detail, visible light communication device 3 to generate and emit the second light by using the light guide plate. As a result, visible light communication device 3 enables the receiving device to more surely receive communication light.

It is further possible that the first light-emitting region is a region including a light source that emits the first light, and the second light-emitting region is a region including a reflective plate that receives the first light from the light source and reflects a part of the first light received to emit the second light.

This structure allows, in more detail, visible light communication device 4 to generate and emit the second light by using the light guide plate. As a result, visible light communication device 4 enables the receiving device to more surely receive communication light.

It is still further possible that the first light-emitting region is a region including a first light source that emits the first light, and the second light-emitting region is a region including a second light source that is different from the first light source and emits the second light.

This structure allows each of visible light communication devices 5 and 6 to generate and emit the second light by using a light source different from the light source of the first light. As a result, each of visible light communication devices 5 and 6 enables the receiving device to more surely receive communication light.

### Embodiment 4

According to Embodiment 4, description is given for an example where the structure of the light source unit of the visible light communication device according to Embodiment 3 is applied to a light of an automobile.

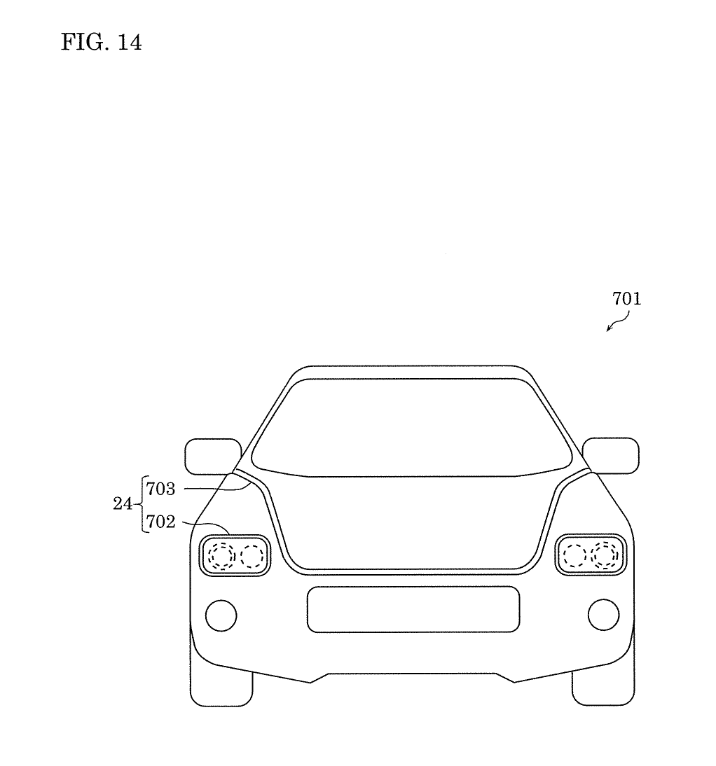

FIG. 14 is a schematic diagram of automobile 701 having, as a light, a light source unit of visible light communication device 7 according to Embodiment 4.

Automobile 701 includes headlight 702 and body illumination 703. Headlight 702 and body illumination 703 form light source unit 24 of visible light communication device 7.

Headlight 702 is a headlight that illuminates the front of automobile 701 when automobile 701 moves in the dark. Headlight 702 emits light having high luminance to brightly illuminate the darkness.

Body illumination 703 is a light that is provided to the exterior of the body of automobile 701 as decoration. Body illumination 703 is provided to be visible in the dark. Therefore, body illumination 703 emits light having lower luminance than luminance of light of headlight 702.

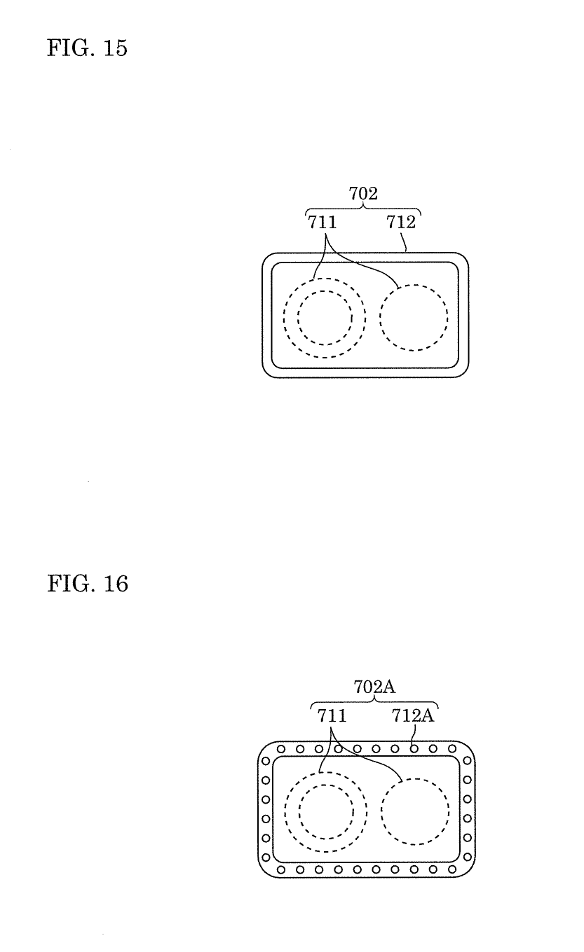

FIG. 15 is an enlarged diagram of a first example of light source unit 24 of visible light communication device 7 according to Embodiment 4.

As illustrated in FIG. 15, headlight 702 includes body part 711 and periphery part 712.

Body part 711 is a light source that is lit up to brightly illuminate the darkness.

Periphery part 712 is a light for decoration provided to the periphery of body part 711. Periphery part 712 is provided to be visible in the darkness. Therefore, periphery part 712 emits light having lower luminance than luminance of body part 711.

Light source unit 24 emits light from body part 711 as main communication light, and emits light from periphery part 712 and body illumination 703 as sub communication light. This structure allows automobile 701 (visible light communication device 7) to illuminate the front by headlight 702, and transmit information to receiving device 10 by the sub communication light.

FIG. 16 is an enlarged diagram of a second example of the light source unit of the visible light communication device according to Embodiment 4.

The structure of headlight 702A illustrated in FIG. 16 differs from headlight 702 illustrated in FIG. 15 in the structure of periphery part 712A.

Periphery part 712A has a structure allowing the light source to be more visible, in comparison to periphery part 712. Since the light source can be clearly visible, periphery part 712A has higher visual effects than those of periphery part 712. Like periphery part 712, periphery part 712A emits sub communication light.

As described above, headlight 702A produces the same effects as those of headlight 702.

(Other Variations)

Although the visible light communication system according to the present disclosure has been described based on the above embodiments and variations, the present disclosure is not limited to the embodiments and variations.

The general and specific aspects according to the above-described embodiments may be implemented to a system, a method, an integrated circuit, a computer program, or a computer-readable recording medium such as a Compact Disc-Read Only Memory (CD-ROM), or may be any combination of them.

While the foregoing has described what are considered to be the best mode and/or other examples, it is understood that various modifications may be made therein and that the subject matter disclosed herein may be implemented in various forms and examples, and that they may be applied in numerous applications, only some of which have been described herein. It is intended by the following claims to claim any and all modifications and variations that fall within the true scope of the present teachings.

What is claimed is:

1. A visible light communication device comprising:
a light source unit configured to emit light for visible light communication; and
a control circuit that generates an original signal of the light to be emitted by the light source unit,
wherein the control circuit generates the original signal that includes a payload part, a Cyclic Redundancy Check (CRC) part, and a recognition part, the payload part including identification information identifying the visible light communication device, the CRC part being determined according to data indicated in the payload part, and the recognition part being arranged immediately subsequent to the CRC part.

2. The visible light communication device according to claim 1,
wherein the recognition part is shorter than a preamble part arranged immediately prior to the payload part.

3. The visible light communication device according to claim 1,
wherein the recognition part has a predetermined fixed signal pattern.

4. The visible light communication device according to claim 1,
wherein the recognition part has a pattern not complying with 4-ary Pulse Position Modulation (4PPM) coding rule of CP-1223 standard.

5. The visible light communication device according to claim 1,
wherein the recognition part is a signal that enables a receiving device receiving the light to find the CRC part arranged immediately prior to the recognition part and identify the visible light communication device by using the CRC part.

6. The visible light communication device according to claim 1, further comprising
a radio beacon transmission circuit that transmits a signal by radio waves,
wherein the control circuit generates (a) the original signal including a part of the identification information and (b) a signal including a remaining part of the identification information, and causes the radio beacon transmission circuit to transmit (b) the signal generated.

7. The visible light communication device according to claim 1,
wherein the light includes (a) first light having a predetermined intensity and (b) second light having a lower intensity than the predetermined intensity of the first light, and
the light source unit includes a first light-emitting region and a second light-emitting region, the first light-emitting region emitting the first light, and the second light-emitting region emitting the second light and being different from the first light-emitting region.

8. The visible light communication device according to claim 7,
wherein the first light-emitting region is a region including a light source that emits the first light, and
the second light-emitting region is a region including a light guide plate that receives the first light from the light source, internally diffuses the first light received to emit second light from a surface of the light guide plate.

9. The visible light communication device according to claim 7,
wherein the first light-emitting region is a region including a light source that emits the first light, and
the second light-emitting region is a region including a reflective plate that receives the first light from the light source and reflects a part of the first light received to emit the second light.

10. The visible light communication device according to claim 7,
wherein the first light-emitting region is a region including a first light source that emits the first light, and
the second light-emitting region is a region including a second light source that is different from the first light source and emits the second light.

11. A receiving device for visible light communication, the receiving device comprising:
a light receiver that receives light from a visible light communication device; and
a control circuit that extracts an original signal of the light received by the light receiver,
wherein the control circuit obtains a recognition part from the original signal, and obtains a CRC part arranged immediately prior to the obtained recognition part from the original signal as a signal for identifying the visible light communication device.
